(19) United States
(12) Patent Application Publication
(10) Pub. No.: US 2022/0195633 A1
(43) Pub. Date: Jun. 23, 2022

(54) A FIBER FROM WASTE MATERIAL AND METHODS OF PRODUCING

(71) Applicant: Avery Dennison Retail Information Services LLC, Mentor, OH (US)

(72) Inventors: Alberto MORELLI, San Benedetto del Tronto (IT); Mathieu DE BACKER, Grottammare (IT)

(21) Appl. No.: 17/603,814

(22) PCT Filed: May 6, 2020
(86) PCT No.: PCT/US2020/031703

§ 371 Date: Oct. 14, 2021

Related U.S. Application Data
(60) Provisional application No. 62/843,736, filed on May 6, 2019.

(51) Int. Cl. D01G 11/04; D02G 3/02

(52) U.S. Cl. CPC D01G 11/04; D10B 2401/16; D02G 3/02

(57) ABSTRACT

Provided herein are methods for producing a fiber from a waste material comprising: (i) fraying a waste material to form a fiber base; (ii) carding the fiber base to form a recovered fiber; and (iii) spinning the recovered fiber. The waste material may comprise manufacturing scraps, damaged materials, selvedges, or combinations thereof. In some embodiments, the method may further comprise reducing the size of the waste material prior to fraying and/or blending the fiber base. Also described herein is a fiber produced from waste material using the disclosed methods.

### FIELD

The present disclosure relates generally to fibers produced from waste products in the fiber and textile industry and methods of producing these products. In particular, the waste products from the fiber and textile industry are those generated at the production facilities.

### BACKGROUND

It is increasingly important to provide sustainable products in the fiber and textile industry. Sustainable products may be provided from such sources which conform to certain sustainability principles for decreasing the environmental footprint of a product. Sustainable products may provide environmental benefits while protecting the environment over their whole life cycle of the product, from the extraction of raw materials until the final disposal of that product. Methods of producing fibers from surplus or waste fibers, including but not limited to yarns and fabrics, are known in the industry. These known techniques for recycling fibers typically involve heat and chemicals, which increase the environomental impact of a product. Specifically, the processes for recycling fibers include a significant use of water, thermal energy, electricity, production fumes, and harmful chemicals. Further, there can potentially be some concerns over any disposal of waste products from the recycling process.

In the formation of products using fibers and textiles, there is an inherent level of waste that is typically tolerated. Due to a variety of factors, such as sizing, shaping, and cutting to form products, scraps of textiles are left as waste products. The scraps or waste products generated while forming these products are typically disposed, as they are deemed unfit for any other use due to their size, shape, or composition. Further, scrap fibers may also be collected from manufacturing facilities. As such, a need exists to reduce any environmental impact during this formation of products using fibers and textiles.

### SUMMARY

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one embodiment, a method for producing a fiber from a waste material comprising: (i) fraying a waste material to form a fiber base; (ii) carding the fiber base to form a recovered fiber; and (iii) spinning the recovered fiber. The waste material may comprise manufacturing scraps, damaged materials, selvedges (also known as weaving waste), or combinations thereof.

In some embodiments, the method may further comprise reducing the size of the waste material where the waste material is a large waste material. In many embodiments, reducing the size of the waste material may be prior to fraying the waste material. In some embodiments, the waste material prior to fraying is a large waste material. In many embodiments, reducing the size of a large waste material comprises cutting, chopping, shredding, or combinations thereof.

In some embodiments, the method may further comprise blending the fiber base. In many embodiments, blending the fiber base may be prior to carding the fiber base.

In some embodiments, the method may further comprise providing bales of the fiber base after fraying the waste material.

In some embodiments, carding the fiber base to form a recovered fiber selectively removes at least one short fiber from the fiber base. In some embodiments, carding the fiber base to form the recovered fiber further comprises separating fibers of the fiber base, straightening fibers of the fiber base, or combinations thereof during carding.

In some embodiments, carding the fiber base to form the recovered fiber may further comprise forming a web.

In some embodiments, the method may further comprise dyeing the recovered fiber.

In some embodiments, a fiber may be produced by the methods described herein. In many embodiments, a fiber may be produced from waste material, wherein the waste material comprises manufacturing scraps, damaged materials, selvedges, or combinations thereof. In many embodiments, a fiber produced from waste material may be provided using the methods disclosed herein.

### BRIEF DESCRIPTION OF DRAWINGS

The disclosure references the appended drawings, wherein like numerals designate similar parts. Advantages of embodiments of the present invention will be apparent from the following detailed description of the exemplary embodiments thereof, which description should be considered in conjunction with the accompanying drawings in which like numerals indicate like elements, in which:

FIG. 1 illustrates an exemplary configuration of the method of producing a fiber from waste products.

FIG. 2 illustrates an exemplary configuration of the method of producing a fiber from waste products.

FIG. 3 illustrates an exemplary configuration of the method of producing a fiber from waste products.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

The present disclosure generally relates to producing a fiber from surplus or waste material, collectively “waste material,” that advantageously use the waste material that would otherwise be discarded and also prevent any disposal needed for the waste material. Specifically, producing fibers from waste material, including but not limited to yarns and fabrics, would provide environmental benefits, including but not limited to conserving resources, saving energy, and limiting landfill. Additionally, fibers made from waste materials may be in demand as consumers gravitate toward earth-friendly products.

In the formation of products using textiles, waste materials may be generated due to sizing, shaping, and cutting to form products. These scraps of textiles along with any other waste fibers are left as waste materials. The waste materials generated while forming these products are typically disposed, as they are deemed unfit for any other use due to their size, shape, or composition. In many embodiments, the waste materials may be provided from manufacturing scraps, damaged materials, selvedges, or combinations thereof. In many embodiments, the waste material comprises cotton, wool, silk, alpaca fiber, yak fiber, camel fiber, llama fiber, mohair, cashmere fiber, chiengora fiber, angora fiber, silk, linen, jute, hemp, corn fiber, coir fiber, ramie, sisal fiber, soybean fiber, bamboo fiber, polyester, polypropylene, polyethylene, nylon, rayon, fiberglass, carbon fiber, polyetheretherketone, acetate, acrylic, polyvinylchlorine, cellulosic fiber, elastane, or combinations thereof.

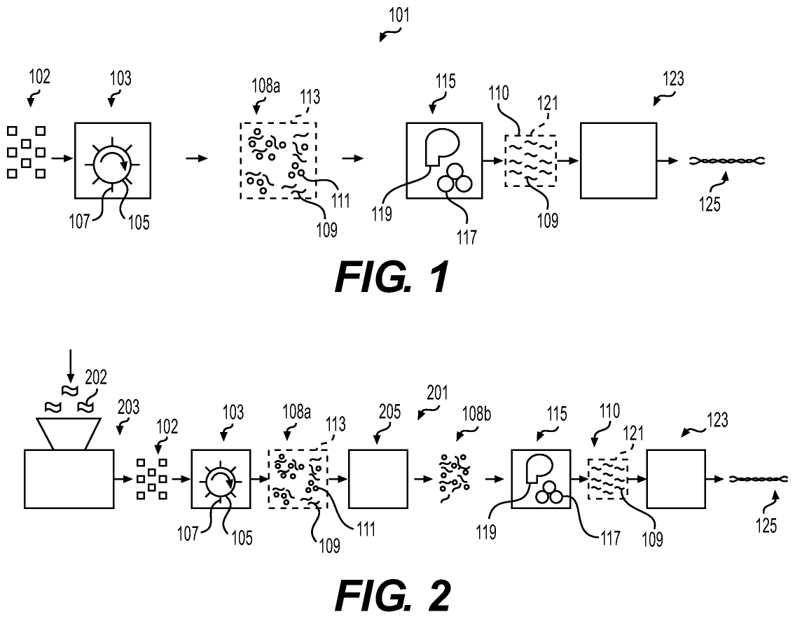

Referring to exemplary FIG. 1, an embodiment of the method 101 is described. FIG. 1 illustrates a method for producing a fiber from a waste material comprising: (i) fraying a waste material to form a fiber base; (ii) carding the fiber base to form a recovered fiber; and (iii) spinning the recovered fiber. The waste material may comprise manufacturing scraps, damaged materials, selvedges, or combinations thereof. Specifically, the waste material may be small waste material 102 or large waste material 202 (as shown in FIG. 2), depending on the size of the size of the waste material.

In many embodiments, the waste material may be about 60 cm² to about 3600 cm² (e.g., an 8 cm by 8 cm piece to a 60 cm by 60 cm piece). Overall, the size the waste material can, for example, range from about 60 cm² to about 3600 cm², e.g., from about 60 cm² to about 3000 cm², from about 60 cm² to about 2500 cm², from about 60 cm² to about 2000 cm², from about 60 cm² to about 1500 cm², from about 60 cm² to about 1000 cm², from about 60 cm² to about 500 cm², from about 60 cm² to about 300 cm², from about 60 cm² to about 200 cm², from about 60 cm² to about 150 cm², from about 60 cm² to about 100 cm², from about 60 cm² to about 95 cm², from about 60 cm² to about 90 cm², from about 60 cm² to about 85 cm², to about 65 cm² to about 85 cm², from about 65 cm² to about 80 cm², from about 65 cm² to about 75 cm², or from about 65 cm² to about 70 cm². In terms of upper limits, the size of the waste material can be less than about 3600 cm², e.g., less than 3000 cm², less than 2000 cm², less than 1000 cm², less than 500 cm², less than 250 cm², less than 100 cm², less than 95 cm², less than 90 cm², less than 85 cm², less than 80 cm², less than 75 cm², less than 70 cm², or less than 65 cm². In terms of lower limits, the size of the waste material can be greater than 60 cm², e.g., greater than 65 cm², greater than 70 cm², greater than 75 cm², greater than 80 cm², greater than 85 cm², greater than 90 cm², or greater than 95 cm². Larger sizes, e.g., greater than 100 cm², and smaller sizes, e.g., less than 60 cm², are also contemplated.

Specifically for the waste material, the small waste material 102 shown in FIG. 1 may be about 60 cm² to about 100 cm² (e.g., an 8 cm by 8 cm piece to a 10 cm by 10 cm piece). Overall, the size the waste material can, for example, range from about 60 cm² to about 100 cm², e.g., from about 60 cm² to about 95 cm², from about 60 cm² to about 90 cm², from about 60 cm² to about 85 cm², to about 65 cm² to about 85 cm², from about 65 cm² to about 80 cm², from about 65 cm² to about 75 cm², or from about 65 cm² to about 70 cm². In terms of upper limits, the size of the small waste material 102 can be less than about 100 cm², e.g., less than 95 cm², less than 90 cm², less than 85 cm² C, less than 80 cm², less than 75 cm², less than 70 cm², or less than 65 cm². In terms of lower limits, the size of the waste material can be greater than 60 cm², e.g., greater than 65 cm², greater than 70 cm², greater than 75 cm², greater than 80 cm², greater than 85 cm², greater than 90 cm², or greater than 95 cm². Larger sizes, e.g., greater than 100 cm², and smaller sizes, e.g., less than 60 cm², are also contemplated.

In FIG. 1, the waste material may be small waste material 102, which does not require a further reduction in the size prior to fraying a waste material to form a fiber base. Small waste material 102 may include, but is not limited to, fabric scraps, fiber scraps, yarn scraps, other manufacturing scraps, damaged materials, selvedges, or combinations thereof. In some embodiments, the small waste material 102 may be small fabric scraps.

In many embodiments, the small waste material 102 may be provided for the fraying process step where fraying a waste material forms a fiber base. In some embodiments, fraying may include tearing and cutting the small waste material 102. In many embodiments, fraying may utilize a fraying apparatus 103 to provide the fiber base. In some embodiments, the fraying apparatus 103 may also be referred to as a hammer. In some embodiments, the fraying apparatus 103 used for fraying comprises at least one drum 105 and at least one blade 107. The drum 105 may rotate such that the blades 107 attached to the drum 105 may make contact with the small waste material 102 to effectively fray them to a desired size. The fraying process may provide a fiber base where the fiber base comprises nonuniformly distributed small particles and fibers 108a, fibers 109, small particles 111, or combinations thereof (shown in FIG. 1).

In many embodiments, the fiber base comprising nonuniformly distributed small particles and fibers 108a, fibers 109, small particles 111, or combinations thereof may then undergo further processing. In one embodiment, the method may further comprise providing bales 113 of the fiber base after fraying the waste material. In a particular embodiment, the method may further comprise providing bales 113 of the frayed fibers and small particles 111 after fraying the waste material as shown in FIG. 1. Bales are fiber masses that are pressed to be processed further. The bale format may be easier to handle and convenient for transporting the material and for allowing the storage of the fibers in an orderly fashion.

In many embodiments, the embodiment of the method 101 may comprise carding the fiber base comprising nonuniformly distributed small particles 108a, fibers 109, small particles 111, or combinations thereof to form a recovered fiber comprising fibers 109, aligned fibers 110, or a combination thereof. In many embodiments, carding is a process of separating individual fibers in the fiber base that causes many of the fibers to lie parallel to one another while also removing most of the remaining impurities. Carding continues the cleaning process by removing fibers too short for yarns and fabrics and further separating and straightening the fibers in the fiber base so that they lay parallel to each other. In some embodiments, the carding process may provide a thin sheet of a certain uniform thickness called a web 121. The thickness of the web 121 may be provided at specified thickness. In some embodiments, the web 121 may then be condensed to form a thick strand (not shown in FIG. 1).

In many embodiments, the carding process may be done by carding apparatus 115 to prepare the fibers for further processing including but not limited to spinning. The carding apparatus 115 may also be referred to as a carda. In other embodiments, the carding process may also be done by hand using hand carders (not shown in FIG. 1) instead of using a carding apparatus 115. In another embodiment, the carding process may also be done by hand using hand carders (not shown in FIG. 1) in addition to using a carding apparatus 115.

In many embodiments, the carding apparatus 115 may comprise at least one carding roll 117 and at least one blower 119. At least one carding roll 117 may provide recovered fibers. These recovered fibers comprise fibers 109, aligned fibers 110, or a combination thereof from the fiber base (where the fiber base comprises nonuniformly distributed small particles and fibers 108a, fibers 109, small particles 111, or combinations thereof provided from the fraying process). In some embodiments, carding the fiber base to form the recovered fiber further comprises forming a web. In some embodiments, the recovered fibers comprising the fibers 109, aligned fibers 110, or a combination thereof may be in the form of a web 121. In some embodiments, the web 121 may be thin and uniform.

Although not shown in FIG. 1, the web 121 may optionally be condensed further to form a thick continuous untwisted strand called a sliver. In this optional process, the web 121 may enter into a funnel-shaped device (also called a trumpet) where it is gathered into a rope like mass and formed into the sliver.

In some embodiments, carding the fiber base to form a recovered fiber selectively removes at least one short fiber from the fiber base. A short fiber, also known as a short-stapled fiber, may be less than 35 mm in length, Overall, the length of the short fiber can, for example, range from 33 mm in length, 30 mm in length, 28 mm in length, 25 mm in length, or 23 mm in length. Smaller sizes, e.g., less than 23 mm, are also contemplated. In many embodiments, removing at least one short fiber may provide both increased strength and durability to the recovered fiber. Further, it may be difficult to complete the spinning step using at least one short fiber since its decreased length may not allow for adequate spinning to provide the recovered fiber.

In other embodiments, carding the fiber base to form the recovered fiber further comprises separating fibers of the fiber base, straightening fibers of the fiber base, or combinations thereof during carding (not shown in FIG. 1). In separating the fibers of the fiber base, straightening the fibers of the fiber base, or combinations thereof during carding, a recovered fiber may be produced that is more lustrous and smooth than those without this process.

In many embodiments, the embodiment of the method 101 may comprise spinning the recovered fiber. With spinning, the recovered yarn may be twisted into a strong, consistent, and continuous yarn or thread for later use. In many embodiments, spinning the recovered fiber may be done with a spinning apparatus 123. In many embodiments, spinning the recovered fiber may provide a yarn of spun and stretched fibers 125.

In some embodiments, spinning the recovered fiber further comprises obtaining a specified title and specified resistance. Title is the length of fiber with respect to a specified weight. In some embodiments, title is related to a length of a fiber per kilogram. In many embodiments, the recovered fiber may be processed to a specified title. Resistance is the mechanical capacity of a fiber. Resistance may also be referred to as the tension. In many embodiments, the recovered fiber may be processed to a specified resistance.

Referring now to exemplary FIG. 2, an embodiment of the method 201 is described. FIG. 2 illustrates a method for producing a fiber from a waste material comprising: (i) reducing the size of a waste material; (ii) fraying a waste material to form a fiber base; (iii) blending the fiber base; (iv) carding the fiber base to form a recovered fiber; and (v) spinning the recovered fiber. Although FIG. 2 provides both (i) reducing the size of a large waste material and (iii) blending the fiber base, it is contemplated that both of these steps are optional to produce a fiber from a waste material.

The waste material may comprise manufacturing scraps, damaged materials, selvedges, or combinations thereof. As shown in FIG. 2, the waste material provided may be a large waste material 202. In some embodiments, the method 201 may comprise reducing the size of a large waste material 202 prior to fraying the waste material.

Specifically, the sizes of the large waste material 202 can, for example, range from about 100 cm² to about 3600 cm², e.g., from 100 cm² to about 3000 cm², from 100 cm² to about 2500 cm², from 100 cm² to about 2000 cm², from 120 cm² to about 1500 cm², from 120 cm² to about 1000 cm², 120 cm² to about 500 cm², or from 120 cm² to about 250 cm². In terms of upper limits, the size of the large waste material 202 can be less than about 3500 cm², e.g., less than about 3000 cm², less than about 2500 cm², less than about 2000 cm², less than about 1500 cm², less than about 1000 cm², less than about 500 cm², or about 250 cm². In terms of lower limits, the size of the large waste material 202 can be greater than about 120 cm², e.g., greater than about 150 cm², greater than about 200 cm², greater than about 250 cm², greater than about 500 cm², or greater than about 120 cm². Larger sizes, e.g., greater than about 3500 cm², and smaller sizes, e.g., less than about 120 cm², are also contemplated.

Alternatively but not shown in FIG. 2, waste material that is not considered to be the size of the large waste material 202 may also undergo reducing the size of the waste material. In one embodiment, the small waste material 102 (as shown in FIG. 1 but not FIG. 2) may optionally be cut further in reducing the size of the waste material.

In many embodiments, reducing the size of the waste material comprises cutting, chopping, shredding, or combinations thereof. In some embodiments, reducing the size of the large waste material 202 comprises cutting, chopping, shredding, or combinations thereof. Alternative methods for reducing the size of the large waste material 202 are also contemplated. In many embodiments, reducing the size of the waste material may be done using a cutting apparatus 203. The cutting apparatus 203 may cut, chop, and/or shred the large waste material 202 to a particular size. In some embodiments, the cutting apparatus 203 may provide waste material that is a small waste material 102, as shown in FIG. 2.

In some embodiments, reducing the size of the large waste material 202 further comprises humidifying the large waste material 202. The humidification process may help to eliminate or minimize any electrostatic charges. In some embodiments, the humidification process uses minimal or trace amounts of water. In some embodiments, about 0.1% to about 5% of vaporized water may be used in the humidification process where the humidification occurs at room temperature (about 20° C.). In another embodiment, about 0.5% to about 3% of vaporized water may be used in the humidification process where the humidification occurs at room temperature (about 20° C.). In one embodiment, about 1% to about 2% of vaporized water may be used in the humidification process where the humidification occurs at room temperature (about 20° C.).

Optionally (but not shown in FIG. 2), the small waste material 102 may undergo a humidification step like that in humidifying the large waste material 202.

In some embodiments, reducing the size of the large waste material 202 further comprises adding at least one anti-static product to the waste material. In many embodiments, the anti-static products may be anti-static products known in the industry. In many embodiments, at least one anti-static product may be one that is compatible with the cutting apparatus 203. In some embodiments, the waste material may be the large waste material 202. In other embodiments, the waste material may be the small waste material 102. In another embodiment, adding at least one anti-static product to the waste material may include both the large waste material 202 and the small waste material 102. The anti-static products may allow facilitate the flow of the waste material both in the subsequent spinning as well as in the final use in weaving looms. In one embodiment, the anti-static product may be provided using vaporized water. In other embodiments, the anti-static product may be provided using a mix of water and anti-static product. In many embodiments, the anti-static products may be anti-static products known in the industry.

After reducing the size of the waste material, the waste material may be subject to the fraying process similar to what was described for FIG. 1. In many embodiments, the small waste material 102 may be provided for the fraying process step where fraying a waste material forms a fiber base. In some embodiments, fraying may include tearing and cutting the yarns and/or fibers of the small waste material 102. In many embodiments, fraying may utilize a fraying apparatus 103 to provide the fiber base. In some embodiments, the fraying apparatus 103 may also be referred to as a hammer. In some embodiments, the fraying apparatus 103 used for fraying comprises at least one drum 105 and at least one blade 107. The drum 105 may rotate such that the blades 107 attached to the drum 105 may make contact with the small waste material 102 to effectively fray them to a desired size. The fraying process may provide a fiber base where the fiber base comprises nonuniformly distributed small particles and fibers 108a, fibers 109, small particles 111, or combinations thereof.

In many embodiments, the fiber base comprising nonuniformly distributed small particles and fibers 108a, fibers 109, small particles 111, or combinations thereof may then undergo further processing. In some embodiments, the method may further comprise providing bales of the fiber base after fraying the waste material. In particular embodiments, the method may further comprise providing bales 113 of the frayed fibers and small particles 111 after fraying the waste material as shown in FIG. 2. The bale format may be easier to handle and convenient for transporting the material and for allowing the storage of the fibers in an orderly fashion.

In many embodiments, the embodiment of the method 201 further includes blending the fiber base after raying the waste material. In many embodiments, blending the fiber base is prior to carding the fiber base. Blending the fiber base may aid in providing a more uniform fiber base. Blending the fiber base may be done in a blending apparatus 207. Blending the fiber base may include, but is not limited to, mixing, blending, combining, or incorporating the individual fibers of the fiber base together. In some embodiments, blending the fiber base may be done with mixing blades. In other embodiments, blending the fiber base may be done with at least one blower. In some embodiments, blending the fiber base is done using an air blower chamber and at least one blower, wherein at least one blower provides air to the fiber base. In yet other embodiments, blending the fiber base may be done by other mechanical means.

In many embodiments, blending the fiber base may provide uniformly distributed fibers and small particles 108b as shown in FIG. 2. These uniformly distributed fibers and small particles 108b may allow for a more desirable recovered fiber that is more lustrous and smooth.

In some embodiments, blending the fiber base further comprises humidifying during blending the fiber base. The humidification process may help to eliminate or minimize any electrostatic charges. In some embodiments, the humidification process uses minimal or trace amounts of water.

In some embodiments, blending the fiber base further comprises adding at least one anti-static product. The anti-static products may allow facilitate the flow of the fiber base both in the subsequent spinning as well as in the final use in weaving looms. In many embodiments, the anti-static products may be anti-static products known in the industry.

In FIG. 2, the uniformly distributed fibers and small particles 108b may then undergo carding the fiber base to form a recovered fiber. In some embodiments, the carding process may provide a thin sheet of a certain uniform thickness called a web 121. In some embodiments, the web 121 may then be condensed to form a thick strand (not shown in FIG. 2). The carding process may be done by hand using hand carders (not shown in FIG. 2) or a carding apparatus 115 to prepare the fibers for further processing including but not limited to spinning. The carding apparatus 115 may also be referred to as a carda.

In many embodiments, the carding apparatus 115 may comprise at least one carding roll 117 and at least one blower 119. At least one carding roll 117 may provide recovered fibers. These recovered fibers comprise fibers 109, aligned fibers 110, or a combination thereof from the fiber base (where the fiber base comprises nonuniformly distributed small particles and fibers 108a, fibers 109, small particles 111, or combinations thereof provided from the fraying process). In some embodiments, carding the fiber base to form the recovered fiber further comprises forming a web. In some embodiments, the recovered fibers comprising the fibers 109, aligned fibers 110, or a combination thereof may be in the form of a web 121. In some embodiments, the web 121 may be thin and uniform. Although not shown in FIG. 2, the web 121 may optionally be condensed further to form a thick continuous untwisted strand called sliver. In this optional process, the web 121 may enter into a funnel-shaped device (also called a trumpet) where it is gathered into a rope like mass and formed into the sliver.

In some embodiments, carding the fiber base to form a recovered fiber selectively removes at least one short fiber (as described above). In many embodiments, removing at least one short fiber may provide both increased strength and durability to the recovered fiber. Further, it may be difficult to complete the spinning step using at least one short fiber since its decreased length may not allow for adequate spinning to provide the recovered fiber.

In other embodiments, carding the fiber base to form the recovered fiber further comprises separating fibers of the fiber base, straightening fibers of the fiber base, or combinations thereof during carding (not shown in FIG. 2). In separating the fibers of the fiber base, straightening the fibers of the fiber base, or combinations thereof during carding, a more desirable recovered fiber may be produced that is more lustrous and smooth.

In many embodiments, the embodiment of the method 201 may comprise spinning the recovered fiber. With spinning, the recovered yarn may be twisted into a strong, consistent, and continuous yarn or thread for later use. In many embodiments, spinning the recovered fiber may be done with a spinning apparatus 123. In many embodiments, spinning the recovered fiber may provide a yarn of spun and stretched fibers 125.

In some embodiments, spinning the recovered fiber further comprises obtaining a specified title and specified resistance.

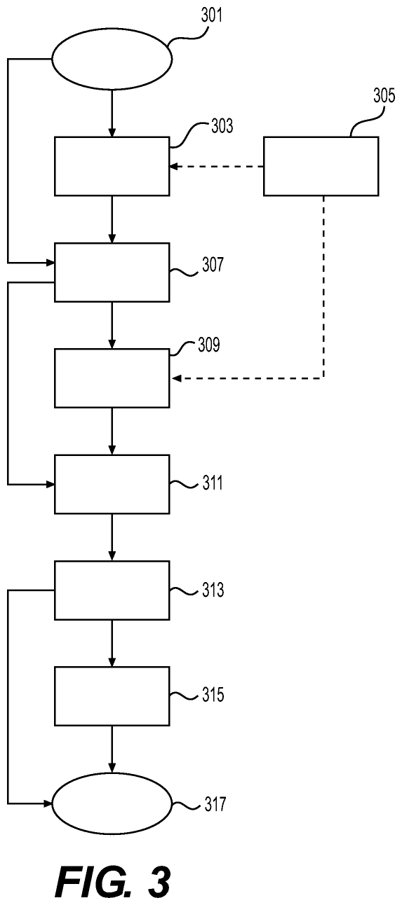

Referring now to exemplary FIG. 3, another embodiment of the method is described in a flowchart form where some optional steps may be illustrated. At the start 301 of the method, a waste material may undergo either reducing the size 303 as described herein or fraying 307 as described herein. If the waste material is subjected to reducing the size 303, then an optional step of humidifying, adding an anti-static product, or combinations thereof, as described herein, may be done.

If the waste material is first subjected to reducing the size 303, then the process will continue to fraying 307 as described herein.

In some embodiments, the process may continue to carding 311 as described herein after fraying 307. In other embodiments, the process may then continue to blending 309 as described herein after fraying 307. If blending 309 is done, then the process continues to carding 311 as described herein.

After carding 311, the process continues to spinning 313 as described herein.

In some embodiments, the process may further comprise dyeing 315 the recovered fiber after spinning as described herein. In other embodiments, the process may continue to the end 317 after spinning 313 if dyeing is not preferred or needed. If dyeing 315 is done, then the process continues to the end 317.

In dyeing 315, the fiber produced from the method described herein may be subjected to a dyeing 315 process. In the dyeing 315 process, the fiber may be further processed to provide a particular color to the fiber. In some embodiments, the color may be a defined color. In many embodiments, the fiber used in the dyeing process may be the yarn of spun and stretched fibers 125 shown in FIG. 2.

Also disclosed herein is a fiber produced by the method described herein. Specifically, a fiber may be produced from a waste material comprising: (i) fraying a waste material to form a fiber base; (ii) carding the fiber base to form a recovered fiber; and (iii) spinning the recovered fiber. In some embodiments, the fiber may be produced by the method described herein where the method further comprises reducing the size of the waste material prior to fraying. In some embodiments, the fiber may be produced by the method described herein where the method further comprises blending the fiber base. In some embodiments, the fiber may be produced by the method described herein where the method further comprises dyeing the recovered fiber.

Also described is a fiber produced from waste material, wherein the waste material comprises manufacturing scraps, damaged materials, selvedges, or combinations thereof. The waste materials may be generated due to sizing, shaping, and cutting to form products. These scraps of textiles along with any other waste fibers are left as waste materials. The waste materials generated while forming these products are typically disposed, as they are deemed unfit for any other use due to their size, shape, or composition. The method disclosed herein allows a fiber to be produced from waste material.

The following embodiments are contemplated. All combinations of features and embodiments are contemplated.

Embodiment 1: A method of producing a fiber from a waste material comprising: (i) fraying a waste material to form a fiber base; (ii) carding the fiber base to form a recovered fiber; and (iii) spinning the recovered fiber.

Embodiment 2: An embodiment of embodiment 1 where the waste material comprises cotton, wool, silk, alpaca fiber, yak fiber, camel fiber, llama fiber, mohair, cashmere fiber, chiengora fiber, angora fiber, silk, linen, jute, hemp, corn fiber, coir fiber, ramie, sisal fiber, soybean fiber, bamboo fiber, polyester, polypropylene, polyethylene, nylon, rayon, fiberglass, carbon fiber, polyetheretherketone, acetate, acrylic, polyvinylchlorine, cellulosic fiber, elastane, or combinations thereof.

Embodiment 3: An embodiment of embodiment 1 or 2, where the waste material comprises manufacturing scraps, damaged materials, selvedges, or combinations thereof.

Embodiment 4: An embodiment of any of the embodiments of embodiment 1-3, where the waste material is about 60 cm² to about 100 cm², or wherein the waste material is about 65 cm² to about 85 cm².

Embodiment 5: An embodiment of any of the embodiments of embodiment 1-4, where a fraying apparatus is used for fraying and wherein the fraying apparatus comprises at least one drum and at least one blade.

Embodiment 6: An embodiment of any of the embodiments of embodiment 1-5, further comprising providing bales of the fiber base after fraying the waste material.

Embodiment 7: An embodiment of any of the embodiments of embodiment 1-6, where carding the fiber base to form a recovered fiber selectively removes at least one short fiber from the fiber base.

Embodiment 8: An embodiment of any of the embodiments of embodiment 1-7, where carding the fiber base to form the recovered fiber further comprises separating the fibers of the fiber base, straightening the fibers of the fiber base, or combinations thereof during carding.

Embodiment 9: An embodiment of any of the embodiments of embodiment 1-8, where carding the fiber base to form the recovered fiber further comprises forming a web.

Embodiment 10: An embodiment of any of the embodiments of embodiment 1-9, where spinning the recovered fiber further comprises obtaining a specified title and specified resistance.

Embodiment 11: An embodiment of any of the embodiments of embodiment 1-10, further comprising reducing the size of a waste material prior to fraying the waste material to form a fiber base, wherein the waste material is a large waste material and wherein reducing the size of a large waste material comprises cutting, chopping, shredding, or combinations thereof.

Embodiment 12: An embodiment of embodiment 11, where the large waste material is about 120 cm² to about 3500 cm², or the large waste material is about 120 cm² to about 1000 cm².

Embodiment 13: An embodiment of any of the embodiments of embodiment 11 or 12, where reducing the size of the large waste material further comprise humidifying the large waste material.

Embodiment 14: An embodiment of any of the embodiments of embodiment 11-13, where reducing the size of the large waste material further comprises adding at least one anti-static product to the waste material.

Embodiment 15: An embodiment of any of the embodiments of embodiment 1-14, further comprising blending the fiber base prior to carding the fiber base to form a recovered fiber.

Embodiment 16: An embodiment of embodiment 15, where blending the fiber base is done using an air blower chamber and at least one blower, wherein at least one blower provides air to the fiber base.

Embodiment 17: An embodiment of any of the embodiments of embodiment 15 or 16, further comprising blending the cut fibers with at least one anti-static product.

Embodiment 18: An embodiment of any of the embodiments of embodiment 1-17, further comprising dyeing the recovered fiber.

Embodiment 19: A fiber produced by the method of any of the embodiments of embodiments 1-18.

Embodiment 20: A fiber produced from waste material, where the waste material comprises manufacturing scraps, damaged materials, selvedges, or combinations thereof.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

While the disclosure has been described in detail, modifications within the spirit and scope of the disclosure will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the disclosure.

1. A method of producing a fiber from a waste material comprising:
fraying a waste material to form a fiber base;
carding the fiber base to form a recovered fiber; and
spinning the recovered fiber.

2. The method of claim 1, wherein the waste material comprises cotton, wool, silk, alpaca fiber, yak fiber, camel fiber, llama fiber, mohair, cashmere fiber, chiengora fiber, angora fiber, silk, linen, jute, hemp, corn fiber, coir fiber, ramie, sisal fiber, soybean fiber, bamboo fiber, polyester, polypropylene, polyethylene, nylon, rayon, fiberglass, carbon fiber, polyetheretherketone, acetate, acrylic, polyvinylchlorine, cellulosic fiber, elastane, or combinations thereof.

3. The method of claim 1, wherein waste material comprises manufacturing scraps, damaged materials, selvedges, or combinations thereof.

4. The method of claim 1, wherein the waste material is a small waste material, and the small waste material is about 60 cm² to about 100 cm².

5. The method of claim 1, wherein the waste material is a small waste material, and the small waste material is about 65 cm² to about 85 cm².

6. The method of claim 1, wherein a fraying apparatus is used for fraying and wherein the fraying apparatus comprises at least one drum and at least one blade.

7. The method of claim 1, further comprising providing bales of the fiber base after fraying the waste material.

8. The method of claim 1, wherein carding the fiber base to form a recovered fiber selectively removes at least one short fiber from the fiber base.

9. The method of claim 1, wherein carding the fiber base to form the recovered fiber further comprises separating fibers of the fiber base, straightening fibers of the fiber base, or combinations thereof during carding.

10. The method of claim 1, wherein carding the fiber base to form the recovered fiber further comprises forming a web.

11. The method of claim 1, wherein spinning the recovered fiber further comprises obtaining a specified title and specified resistance.

12. The method of claim 1, further comprising:
reducing the size of a waste material prior to fraying the waste material to form a fiber base,
wherein the waste material is a large waste material; and
wherein reducing the size of a large waste material comprises cutting, chopping, shredding, or combinations thereof.

13. The method of claim 12, wherein the large waste material is about 120 cm² to about 3500 cm².

14. The method of claims 12, wherein the large waste material is about 120 cm² to about 1000 cm².

15. The method of claim 12, wherein reducing the size of the large waste material further comprises humidifying the large waste material.

16. The method of a claim 12, wherein reducing the size of the large waste material further comprises adding at least one anti-static product to the waste material.

17. The method of claim 1, further comprising blending the fiber base prior to carding the fiber base to form a recovered fiber.

18. The method of claim 17, wherein blending the fiber base is done using an air blower chamber and at least one blower, wherein at least one blower provides air to the fiber base.

19. The method of claim 1, further comprising blending the cut fibers with at least one anti-static product.

20. The method of claim 1, further comprising dyeing the recovered fiber.

21. A fiber produced by the method of claim 1.

22. A fiber produced from waste material, wherein the waste material comprises manufacturing scraps, damaged materials, selvedges, or combinations thereof.
